(19) United States
(12) Patent Application Publication
(10) Pub. No.: US 2026/0288193 A1
(43) Pub. Date: Sep. 24, 2026

(54) Free Running Counter-Based Timer Memory Controller

(71) Applicant: Google LLC, Mountain View, CA (US)

(72) Inventors: Kshitij Srikant, Bangalore (IN); Raj Shekhar Kashyap, Bangalore (IN); Nilay Shah, Bangalore (IN); Ramesh Babu Dontam, Bangalore (IN)

(21) Appl. No.: 19/084,102

(22) Filed: Mar. 19, 2025

(51) Int. Cl. G06F 1/06; G06F 3/06

(52) U.S. Cl. CPC G06F 1/06; G06F 3/0604; G06F 3/0653; G06F 3/0673

(57) ABSTRACT

The disclosed technology includes a timer logic architecture to reduce dynamic power dissipation by a group of multi-bit (M-bit) timers that operate to, for example, maintain command-to-command timing. The timer logic includes a global free running counter (FRC) that provides snapshots to individual timers and a clock gate logic. The timer logic causes the individual timers to be activated and dissipate power during fewer clock cycles. The disclosed technology may take the form of a device, system or method.

### BACKGROUND

Timer modules play an important role in memory controllers. For example, they are used in maintaining the precise timing required for proper operation. Generally, these modules operate to generate accurate and consistent timing signals to ensure that various commands are executed in the correct sequence and within specified time periods. Functions provided by timer modules include, for example, provision of a synchronized and reliable source of timing signals that coordinate the execution of memory commands. As another example, timer modules assist in maintaining timing requirements for the maximum and minimum time intervals between various commands. They also contribute to reducing memory latency by providing accurate timing for when data is expected to be available on the output. Further, timer modules operate to ensure that commands are not issued too early or too late, which can lead to data corruption or incomplete results.

Toggle power is the power dissipated by a flip-flop when it switches states. It is caused by the charging and discharging of the internal capacitances of the flip-flop. When a flip-flop switches states, the output capacitance is charged or discharged to the new state. This charging and discharging process causes current flows through the transistors in the flip-flop, resulting in power dissipation. The amount of toggle power dissipated depends on factors such as, for example, the frequency at which the flip-flop switches states, the size of the output capacitance, and the supply voltage. Typically, the higher the switching frequency, the larger the output capacitance, the higher the supply voltage and the more toggle power that will be dissipated.

The JEDEC standard for LPDDR memory defines approximately 300 different command-to-command timings, ranging from a few nanoseconds to the order of microseconds. When a command is sent to a DRAM, it typically results in multiple counters being decremented inside the memory controller to ensure all command-to-command timings are maintained. With each counter being approximately 10 bit wide (for operating frequency of a couple hundred MHz), timer logic contributes to a significant portion of dynamic power dissipation along the main command path in memory controllers.

### SUMMARY

The disclosed technology includes a timer logic architecture to reduce dynamic power dissipation by a group of multi-bit (M-bit) timers that operate to, for example, maintain command-to-command timing. The timer logic includes a global free running counter (FRC) that provides snapshots to individual timers and a clock gate logic that together cause the individual timers to be activated and dissipate power during fewer clock cycles. The disclosed technology may take the form of a device, system or method. For example, the device may comprise a memory controller having an M-bit timer. The M-bit timer module comprises a free running counter (FRC) and a plurality of M-bit timer modules. The FRC is coupled to the plurality of M-bit timer modules to provide a current snapshot value of the FRC to each of the plurality of M-bit timer modules. Each of the plurality of M-bit timer modules is coupled to a clock gate logic. The clock gate logic only enables the clock when a load trigger, decrement trigger or timer expired pulse event occurs. As such, less power, e.g., toggle power, is dissipated during operations.

Aspects of the disclosed technology may take the form of a memory controller, apparatus or system, or a method or process for controlling command-to-command timing in a memory controller. For example, the disclosed technology may take the form of an apparatus comprising: a free running counter that maintains a count of a number of clock cycles remaining for a command to be executed; and a timer logic coupled to the free running counter and including at least one timer module, the at least one timer module having a current snapshot input for receiving a current snapshot counter value from the free running counter, an input for receiving one or more timer values associated with a new command and an output, wherein the current snapshot input receives a snapshot counter value from the free running counter and a timer value associated with fully executing a current command, and, wherein the timer module generates a pulse at the output when a timer snapshot value maintained by the timer logic based on a sum of the current snapshot counter value and a first timer value.

In accordance with this aspect of the disclosed technology, the current snapshot counter value is provided to the timer module upon detection of the new command by the memory controller. Further, the first timer value may correspond to a number of clock cycles to complete execution of the new command. The current snapshot counter value may also correspond to a number of clock cycles that remain for a current command being executed by a memory coupled to the memory controller to complete execution.

Further in accordance with this aspect of the disclosed technology, the at least one timer module includes a gated clock input that is coupled to a clock gate logic. The clock gate logic is configurable to generate a first clock pulse to load the timer value to the timer module, a second clock pulse to compute when the timer module expires, and a third clock pulse when the pulse is generated at the output. The timer module may also include a gated clock input that is coupled to a clock gate logic and is configured to operate using only three clock pulses. The clock gate logic can be coupled to a clock enable output of the timer module.

Further in accordance with this aspect of the disclosed technology, the timer module can include two or more logic gates that function as a vector comparator to generate the pulse at the output.

As another example, the disclosed technology may take the form of a memory controller, comprising: a free running counter that maintains a count of the number of clock cycles remaining for a command to complete execution; and a timer logic coupled to the free running counter and including at least one timer module, the at least one timer module having a current snapshot input for receiving a current snapshot value from the free running counter, a timer value input for receiving a timer value associated with a new command and timer expired output, wherein the current snapshot input receives a snapshot counter value from the free running counter and a timer value associated with fully executing a current command, and wherein the timer module includes a gated clock input that is coupled to a clock gate logic and that is configured to generate a first clock pulse to load the timer value to the timer module, a second clock pulse to compute when the timer module expires, and a third clock pulse when the pulse is generated at the timer expired output.

In accordance with this aspect of the disclosed technology, the current snapshot counter value is typically provided to the timer module upon detection of the new command by the memory controller. Further, the timer value may correspond to a number of clock cycles required to complete execution of the new command. Further still, the current snapshot counter value may correspond to a number of clock cycles that remain for a current command being executed by a memory coupled to the memory controller will complete execution.

Further in accordance with this aspect of the disclosed technology, the at least one timer module generates a pulse at the timer expired output when a timer snapshot value maintained by the timer logic is equal to the sum of the current snapshot counter value and a timer value. Further, the clock gate logic is coupled to a clock enable output of the timer module. Further still, the timer module includes two or more logic gates that function as a vector comparator to generate the pulse at the timer expired output.

As another example, the disclosed technology may take the form of a method comprising: detecting, by the memory controller, a new command request; receiving, by a timer module of the memory controller, a current snapshot counter value from a free running counter, the current snapshot counter value indicating a first number of clock cycles for completing execution of a command being executed by a memory coupled to the memory controller; receiving, by the timer module of the memory controller, a timer value for a second number of clock cycles to complete execution of the new command request; summing, by the timer module of the memory controller, the first number of clock cycles and the second number of clock cycles as a timer snapshot value; comparing a current timer snapshot value to the timer snapshot value; and generating a timer expired pulse when the current timer snapshot value is equal to the timer snapshot value.

In accordance with this aspect of the disclosed technology, the method may also comprise using a first clock pulse to update a first register to store the timer value. The method may also comprise using a second clock pulse to update a second register to store the timer snapshot value. The method may also comprise using a third clock pulse to generate the timer expired pulse.

### BRIEF DESCRIPTION OF THE DRAWINGS

FIG. 1 illustratively depicts an example of a system in accordance with an aspect of the disclosed technology.

FIG. 2 illustratively depicts an example of a timer unit in accordance with an aspect of the disclosed technology.

FIG. 3 illustratively depicts a method for operating a memory controller in accordance with an aspect of the disclosed technology.

### DETAILED DESCRIPTION

The disclosed technology includes a timer logic architecture to reduce dynamic power dissipation by a group of multi-bit (M-bit) timers that operate to, for example, maintain command-to-command timing. Consider a set of timers with widths in the range M1, M2, . . . Mn and where M_{MAX} is the width of the timer with the highest command-to-command delay. For such a group of timers, the disclosed architecture includes an M_{MAX} bit global Free Running Counter (referred to as FRC), which provides an Mn bit counter snapshot value to any of the timer modules at any instance. The disclosed counter works on the principle of using a current_snapshot value of the FRC at the time of a decrement_trigger, and calculating an expiration value of when the actual timer should expire. This expiration value is stored in a register (e.g., timer_snasphot) associated with the timer module and is compared with the current_snapshot input to generate a timer expiration pulse. A timer_expired_pulse is then used to toggle the level of output timer_expired.

Each time a new command request is generated, a snapshot is taken of the FRC and the number of cycles needed to complete the new command is added to the FRC. The snapshot is loaded into the register corresponding to the new command. The FRC starts decrementing its counter value and when the number of decrements needed for the new command is reached, a timer expired pulse is generated indicating that the command should be ready to be processed (e.g., read the row associated with the new command). In accordance with the disclosed technology, the timer_snapshot and timer_expired registers need only three pulse instances: (1) load_trigger: to store the loading value of the timer; (2) decrement_trigger: to calculate when the actual timer expires; and (3) timer_expired_pulse: to raise the level output of timer_expired. Each timer module may then be clock gated and be enabled only when events (1), (2) and (3) occur. This reduces dynamic power dissipation for each timer module by gating the clock for a majority of the timer application.

The disclosed technology saves power in that rather than requiring that the clock be ON for 2^{M} cycles or pulses for a M-bit counter, use of a gated clock requires that the clock be ON for 3 clock cycles or pulses. This results in reducing power dissipation for each timer module. While the global FRC clock is ON throughout, the clock power dissipated on one M_{MAX} bit flop is meaningfully less than the power saving done by implementing the above architecture for multiple timer modules, generally in the order of hundreds for memory controller applications. Due to the width of timer_value (M−1 bits) and current_snapshot (M bits) chosen, typically at maximum only one timer_snapshot overflow can occur between consecutive timer load and decrement operations. Additional timer controls may be added without impacting the power saving strategy.

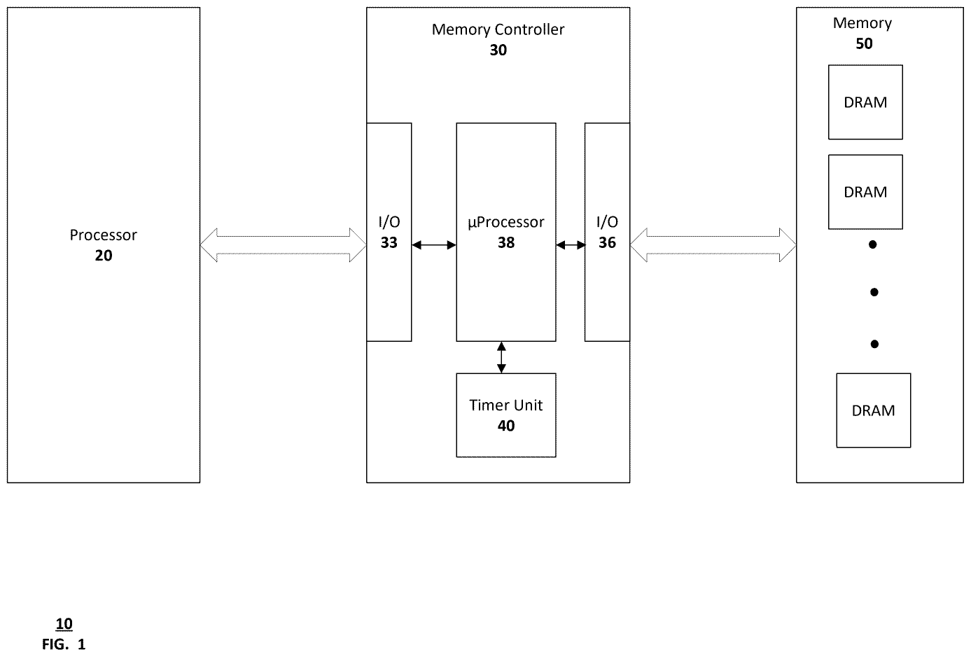

FIG. 1 illustratively depicts an example of a system 10 in accordance with an aspect of the disclosed technology. The system 10 includes a processor 20, a memory controller 30 and a memory 50. The processor 20, memory controller 30 and memory 50 may comprise components that make up a system on a chip (SoC). Alternatively, the processor 20, memory controller 30 and memory 50 may comprise chiplets in a single package. The processor 20, memory controller 30 and memory 50 may also alternatively comprise chiplets in a single integrated circuit such as, for example, a multi-chip module. Other components, e.g., a GPU, WiFi or cellular network radio modems, are not shown for simplicity but may also be components in system 10. The system 10 may be implemented in various electronic devices such as, for example, a smartwatch, cellular phone or smartphone, tablet, laptop computer, desktop computer or, more generally, any electronic device that uses memory.

Processor 20 functions as the primary processor in system 10 and may be considered a central processing unit (CPU). It may execute instructions of one or more computer programs or processes that enable the electronic device to carry out various functions, e.g., phone calls, web searches, health monitoring, word processing, email processing or more generally an application. As part of executing these functions, the processor 20 may request access to memory 50 through memory controller 30. For example, processor 20 may request memory controller 30 to read (or retrieve) data from memory 50 or write (store) data to memory 50.

More generally, memory controller 30 manages communications between the processor 20 and memory 50. In doing so, it controls the flow of data, including commands, to make sure that data is stored and retrieved properly. The memory controller 30 also handles functions associated with the memory 50 including, for example, memory refresh, error correction, power management and other maintenance functions. Typically, a memory controller might have 40 different requests and/or commands that the memory controller needs to process in accessing or performing maintenance functions associated with the memory 50. In addition, memory controller 30 is shown separately from processor 20 but may also be integrated into processor 20.

As shown in FIG. 1, memory 50 may include one or more DRAMs, or any other type of memory that may be accessed via a memory controller. DRAMs, as well as other types of memories, are in essence analog devices (e.g., analog storage cells comprising a capacitor and a transistor) in which memory access requests or commands require some finite time period to be completed. For instance, the cycle time for a read or write operation can be on the order of 100 ns, which does not include access time, precharge time or other times associated with accessing a memory. If two requests are made to the memory before one request is completed, memory operations may be corrupted. The memory controller needs to mitigate against operation failures. For example, in a case where the memory controller 30 has to handle 30 different commands, some minimum time is required between commands to guard against corrupting operations (e.g., a command not completing causing no data to be read or written or the data that is retrieved or written is corrupted).

As shown in FIG. 1, memory controller 30 includes a first input/output (I/O) interface 33 that couples the memory controller to 30 to processor 20 and a second I/O interface 36 that couples the memory controller 30 to memory 50. Memory controller 30 also includes microprocessor 38 and a timer unit 40. The timer unit 40 is shown separately from microprocessor 38 but in some cases may be integrated into microprocessor 38. Microprocessor 38 receives requests from processor 20 to access memory 50, which may include read and write requests for retrieval and storage of data. Microprocessor 38 then issues requests or commands to memory 50 to obtain or store such data, and in the case of a read request return any data obtained to processor 20. In performing such functionality, microprocessor 38 communicates with timer unit 40 to preserve command-to-command timing requirements. For example, in a case where three commands, A, B and C, need to be sent to a DRAM on memory 50, it is necessary to ensure that the proper timing between commands being sent is maintained. If command A requires 10 cycles to be completed and command B requires 15 cycles, command B can be sent to memory 50 10 cycles after command A is sent and command C can be sent 15 cycles after command B is sent.

Typically, the convention is to maintain a timer for each possible command-to-command pair. Where there are 30 commands, there can be as many as 900 command-to-command pairs. This requires maintaining 900 timers. Typically, each timer is a 10-bit timer because commands may take as long as 1000 cycles to complete. Each time a command is issued, 30 timers are triggered for that timer at the same time (one for each possible command-to-command pairing). A timer typically uses a counter to track a counter value (e.g., as a part of count down). The value is stored using a register or flip-flop that requires a clock pulse each time the value is updated, e.g., 11 to 10, 10 to 01, 01 to 00. Each time a register consumes a clock pulse it dissipates power, commonly referred to as dynamic power. In the case where 30 timers are operating, each such timer consumes dynamic power as a result of a counter associated with each timer having to be updated per clock cycle.

The disclosed technology reduces dynamic power dissipation by reducing the number of clock pulses that need to be used to operate a timer module associated with each command-to-command timing process that is enabled by a memory controller. In one aspect, in lieu of maintaining multiple counters (one for each command-to-command timer), a single free running counter is maintained. In another aspect, clock gating logic is used to provide a clock only when needed.

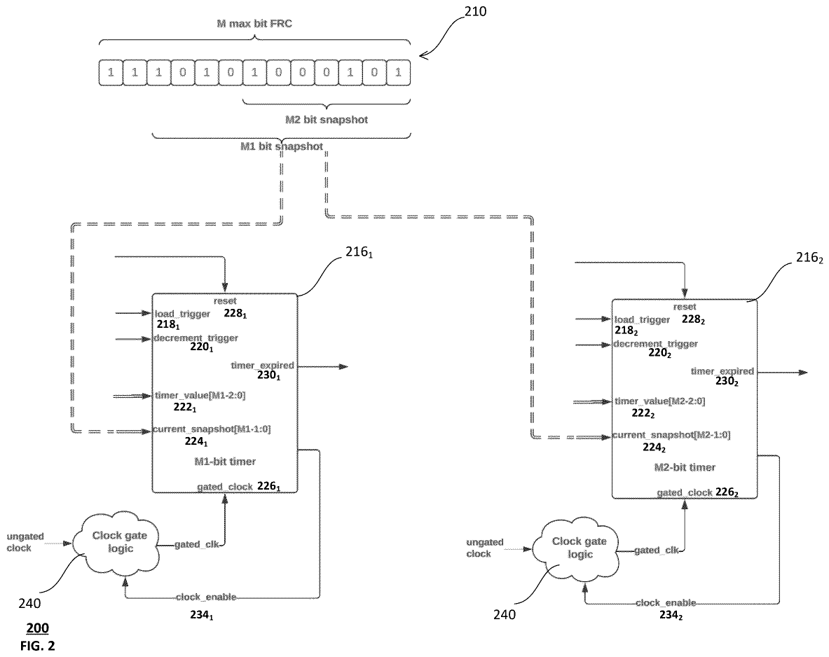

FIG. 2 is a logic diagram showing the arrangement of an example of a timer unit 200 in accordance with an aspect of the disclosed technology. The timer unit 200 includes an M-bit free running counter (FRC) 210, two M-bit timer modules 216₁, 216₂, and a clock gate logic 240. For simplicity, the timer unit 200 is shown with two timers 216₁, 216₂ but may include additional timers to account for other possible command-to-command timing events. As explained previously, it is not uncommon to have several hundred timers operating concurrently. On the other hand, timer unit 200 includes a single counter—FRC 210. The FRC 210 may be integrated into the timer unit 40 or be provided as a separate component in the memory controller. The timer unit 200 may comprise timer unit 40 in FIG. 1 and may be implemented as a digital circuit. Such circuit may be modeled as a register-transfer level (RTL) abstraction which describes the flow of digital signals between different hardware registers and the logical operations performed on the digital signals. The circuit may include registers, flip-flops, resistors, comparators, amplifiers and other circuit elements arranged to implement the functionality described herein. In this regard, the timer unit 40 may comprise integrated circuitry within the controller designed to carry out the functionality described herein. The timer unit may also be implemented as one or more modules. The timer unit may also be implemented as a separate unit or IP as part of a chiplet system.

Generally, a snapshot of the current counter value of FRC 210 is determined when a new command or request is issued or detected by the memory controller, e.g., memory controller 30. A timer module associated with the new command uses the current snapshot value to determine how long before the new command can be issued to the memory device. For instance, consider a case where command A was sent or issued to a memory, e.g., a DRAM in memory 50 of FIG. 1, and is in the process of being executed by the memory. While command A is being executed, a new command B is detected by the controller 38 and which requires 10 clock cycles after command A is fully executed or completed before the memory is ready for another command or request. In this regard, from the perspective of the controller 30, commands are executed towards the memory. Generally, the JEDEC include specifications relating to command-to-command timings that ensure that such timing is as needed for fully completing a command. In other words, the timers of a memory controller only need to ensure that the various command-to-command timings are followed between executing the commands towards the memory.

In accordance with the disclosed technology, a timer module, e.g., timer module 216, is activated or enabled to track the command A to command B timing needed to ensure that command B is not sent to the memory 50 until command A has completed execution and the memory 50 is ready to execute command B. In accordance with FIG. 2, a snapshot of the current value of the counter 210 is provided to timer module 216₁ (e.g., via current_snapshot input 224₁). In addition, the number of clock cycles required to complete command A and ensure that the memory is ready for executing command B is also sent to timer module 216₁ (e.g., via timer_value input 222₁). For example, if the current snapshot value of FRC 210 is 3 and command B requires 10 clock cycles before it can be issued to the memory 50, timer module 216₁would operate to trigger issuance (request execution) of command B in 13 clock cycles, i.e., 10 cycles (for the memory to be ready for command B or another command after command A has been fully executed) and 3 cycles (current number of cycles left for command A to complete execution). Once timer module 216₁ determines that 13 clock cycles have passed, it signals (via timer_expired output 230₁) that time has expired and command B can be sent to the memory 50.

If, while command A is still being executed or processed by the memory, another command C is generated for the memory 50 which requires 15 clock cycles after command A has completed execution before it is sent to the memory, another timer module, e.g., timer module 216₂, would be enabled or triggered into operation by the microprocessor 38 of the memory controller 30. Assuming FRC counter 210 is a countdown counter and at the time command C is detected by the controller 30, FRC 210 has a current snapshot value of 1, this value would be sent to timer module 216₂ (e.g., via current_snapshot input 224₂). In addition, the delay or guard band time of 15 clock cycles would be sent to timer module 216₂ (e.g., via timer_value 222₂). As such, timer module 216₂ would be set to indicate (via timer_expired output 230₂) that command C can be sent to the memory 50 in 16 clock cycles (15 for after command A completes execution and 1 for the current number of cycles left for command A to complete execution).

In addition, another timer module would need to be enabled or become operational to account for the command-to-command timing between command B and command C. As indicated above, at the time command C is detected the current snapshot value is 1. If the command-to-command timing guard band between the command B and command C is 20 clock cycles, then command C would then be sent to the memory 21 clock cycles after command B completes execution. In this regard, command C has to wait to meet all timing requirements, be it from command A to command C, or command B to command C. This is also one reason for having separate timer modules for different command-to-command pairs. Thus, even when command C starts meeting timing requirements with respect to command A in, for example, 15 cycles, it would have to wait until it starts meeting timing requirements with respect to command B as well (which will happen 20 cycles after command B has been executed or sent to memory). In this example, command B would now have to wait to meet timing requirements with respect to both command A and command C. Thus, one timer module would check for timing requirements between A and B, and another module will check timing requirements for C and B. Once both timing checks are satisfied, command B can be issued to the memory.

As a further modification of this example, command A has been executed towards the memory when the FRC snapshot was at value 1. Further, command A to command C timing requirement is 3 cycles, and command A to command B timing requirement is 20 cycles. As part of the memory controller intelligent logic, multiple checks are done to assess which is the right command to be sent to the memory (e.g., which command should have higher priority). After all such checks, each command has to meet the timing requirement nonetheless. Thus, if command C is seen as higher priority than command B, then it only has to wait 3 cycles after command A and can be sent as soon as the FRC snapshot reaches 4. Another way to understand this would be that any command has to only meet timing requirements with the commands that have already been executed to the memory. Thus, since only command A has been executed in our example, command C only has to meet timing requirements with respect to command A. Command B timings do not normally impact command C until command B has actually been executed towards the memory.

As shown in FIG. 2, timer modules 216 each include load_trigger 218, decrement_trigger 220, timer_value 222, current_snapshot 224, gated_clock 226, and reset 228 inputs. Each timer also includes timer_expired 230 and clock_enable 234 outputs. Load_trigger input 218 is a pulse trigger to load or enable a count_down timer. In other words, the load trigger causes a timer module to become operational. Decrement_trigger 220 is a pulse trigger to start counting the timer cycles. Timer_value 222 is a (M−1)-bit input to indicate the number of clock cycles needed to expire the timer module after the decrement_trigger 220 pulse is received. The current_snapshot 224 is the counter value provided by the FRC 210 when a request or command is generated. The current_snapshot 224 value may comprise the lower M-bits (also referred to as the LSB M bits) of the FRC 210. Gated_clock input 226 is the clock supplied to the internal flip-flops in the timer module or logic 216. Reset 228 functions as an asynchronous reset to the internal flip flops of the timer module.

The timer_expired output 230 causes a level signal to stay HIGH when the counter value associated with a timer 216 is 0. This indicates that a command-to-command timer has expired and the respective command can go to the memory.

In operation, the load_trigger 218 causes the timer module 216 to load a counter value associated with a command or request. That counter value is provided via the timer_value 222 and sets the timing which the command or request requires to complete execution by the memory (e.g., a guard band). The timer module 216 also receives the current snapshot value via current_snapshot input 224. The counter or timer value is added to the current snapshot value to form a timer snapshot value. For example, if a command requires 20 clock cycles to be executed and the current_snapshot value is 10 clock cycles, the timer module 216 knows that in 30 clock cycles the counter would have expired and the command or request can be loaded to the memory for execution. In this example, the 30 clock cycles would comprise the timer snapshot value. The decrement_trigger operates to load the timer snapshot value, but decrement operations are not necessary given that the timer knows that in 30 cycles the command/request can be issued to the memory. As such, when the timer snapshot value reaches 30 clock cycles, the timer expired pulse can be generated. This may be implemented using logic gates which can compare the value of two vectors, and generate a stimulus (like a pulse) to signal or indicate when the two values are equal. As such, when the current counter value reaches the timer_value plus the current_snapshot value, the timer has expired. This operation is shown in pseudo code below:
Reg[m−1:0] Timer_snapshot;
Wire timer_expired_pulse;
Always_ff@(posedge gated_clock or negedge reset) begin
   If (reset)
      Timer_snapshot<=′0;
   Else if (load_trigger)
      Timer_snapshot<=Timer_value;
   Else if (Decrement_trigger)
      Timer_snapshot<=Current_snapshot+Timer_snapshot−1′b1;
End//End of always_ff
Assign timer_expired_pulse=(timer_snapshot==current_snapshot);
Always_ff@(posedge gated_clock or negedge reset) begin
   If (reset)
      Timer_expired<=1′b1;
   Else if (decrement_trigger)
      Timer_expired<=1′b0;
   Else if (timer_expired_pulse)
      Timer_expired<=1′b1;
End//End of Always_ff
   In accordance with this aspect of the disclosed technology, the timer_snapshot and the timer_expired reqisters only require a clock during three clock cycles or clock pulses:
   1. load_trigger: to store the load or counter value of the timer (e.g., the time need to execute the command or request)
   2. decrement_trigger: to calculate when the actual timer expires
   3. timer_expired_pulse: to raise the level output of timer_expired

Given that a clock is needed in only three clock cycles, a clock gate is added to each timer module as shown in FIG. 2 such that the clock is enabled only at the time of these three events. This operation is shown in pseudo code below:
Clock_gate_enable=load_trigger or decrement_trigger or timer_expired_pulse
Gated_clock=clock and clock_gate_enable
   This reduces dynamic power dissipation for each timer module by gating the clock for a majority of the timer application.

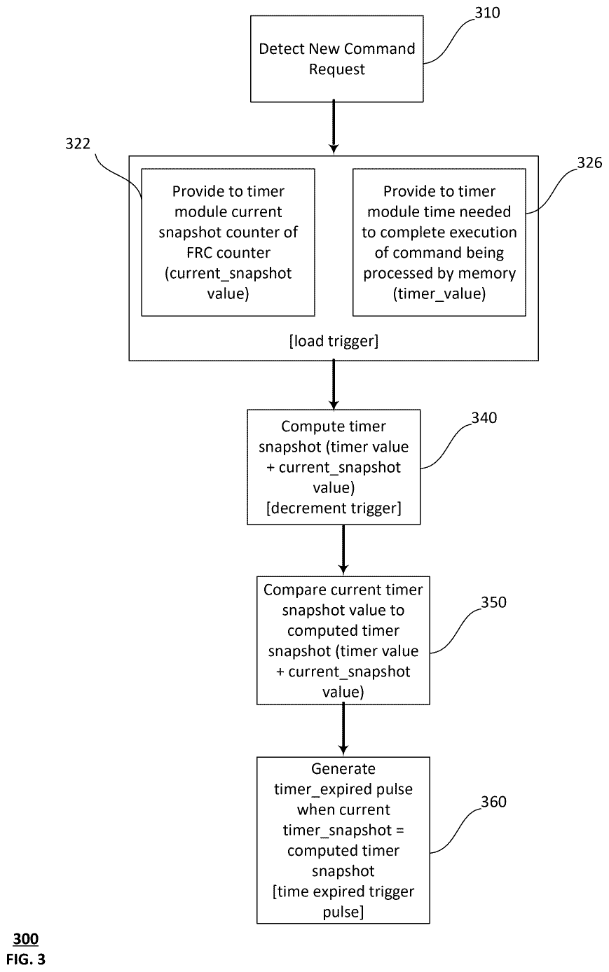

Turning now to FIG. 3, there is illustrated an example of a method 300 for processing commands or requests to a memory device in accordance with an aspect of the disclosed technology. Processing begins upon detection by a memory controller of a new command that requires access to a memory that the memory controller is coupled to, as shown at block 310. The new command request may be detected by a processing element, such as microprocessor 38 in FIG. 1 or a microcontroller. The new command may be a read or write command from a processor associated with the memory controller. The new command may also be a maintenance request or command generated by the memory controller to cause to the memory to, for example, refresh or perform other maintenance activities.

Upon detecting the new command request, one or more timer modules are enabled to manage the command-to-command timing guard bands required to ensure that a proper time interval is maintained between the newly detected command and other commands that are being executed by the memory or in queue to be processed by the memory. For each new command request, a current snapshot value of free running counter (FRC) is provided to the timer module enabled for the new command request, as shown at block 322. In addition, the timer module is also provided with a timer value, which is the time needed to ensure that a current command has been fully executed before the new command can be issued to the memory, block 326. As shown, as part of at least providing the timer value, as shown at block 326, a load trigger is generated. This load trigger requires use of one clock cycle of power to update the register associated with maintaining the timer value.

At block 340, the timer module computes a timer snapshot value by adding the timer value to the FRC current snapshot value. This computation may occur on a decrement trigger with the timer snapshot value being stored by the timer module. As shown, this operation will make use of one more clock cycle of power to update the register associated with maintaining the timer snapshot value.

At block 350, the process continues with the current timer snapshot value of the timer module being compared to the timer snapshot value computed at block 340. As shown at block 360, when the timer module's current timer snapshot value is equal to the computed timer snapshot value, a timer expired pulse is generated by the timer module. The timer expired pulse provides an indication that the memory controller may now provide the command request to the memory for execution. The timer module, for example, may provide the timer expired pulse to a microprocessor or microcontroller of the memory controller, which then causes the new command to be transferred to the memory.

Aspects of the disclosed technology may be embodied in a method, process, apparatus, or system that includes one or more of the following features (e.g., F1 through F20) or sub-features:
F1. A memory controller, comprising:
a free running counter that maintains a count of a number of clock cycles remaining for a command to be executed; and
a timer logic coupled to the free running counter and including at least one timer module, the at least one timer module having a current snapshot input for receiving a current snapshot counter value from the free running counter, an input for receiving one or more timer values associated with a new command and an output, wherein the current snapshot input receives a snapshot counter value from the free running counter and a timer value associated with fully executing a current command, and
wherein the timer module generates a pulse at the output when a timer snapshot value maintained by the timer logic based on a sum of the current snapshot counter value and a first timer value.
F2. The memory controller of F1, wherein the current snapshot counter value is provided to the timer module upon detection of the new command by the memory controller.
F3. The memory controller of F1 or F2, wherein the first timer value corresponds to a number of clock cycles to complete execution of the new command.
F4. The memory controller of any one of F1 to F3, wherein the current snapshot counter value corresponds to a number of clock cycles that remain for a current command being executed by a memory coupled to the memory controller to complete execution.
F5. The memory controller of any one of F1 to F4, wherein the at least one timer module includes a gated clock input that is coupled to a clock gate logic.
F6. The memory controller of any one of F1 to F5, where the clock gate logic is configured to generate a first clock pulse to load the timer value to the timer module, a second clock pulse to compute when the timer module expires, and a third clock pulse when the pulse is generated at the output.
F7. The memory controller of any one of F1 to F6, wherein the clock gate logic is coupled to a clock enable output of the timer module.
F8. The memory controller of any one of F1 to F7, wherein the timer module includes a gated clock input that is coupled to a clock gate logic and is configured to operate using only three clock pulses.
F9. The memory controller of any one of F1 to F8, wherein the timer module includes two or more logic gates that function as a vector comparator to generate the pulse at the timer expired output.
F10. A memory controller, comprising:
a free running counter that maintains a count of a number of clock cycles remaining for a command to complete execution; and
a timer logic coupled to the free running counter and including at least one timer module, the at least one timer module having a current snapshot input for receiving a current snapshot counter value from the free running counter, a timer value input for receiving a timer value associated with a new command and a timer expired output, wherein the current snapshot input receives a snapshot counter value from the free running counter and a timer value associated with fully executing a current command, and
wherein the timer module includes a gated clock input that is coupled to a clock gate logic and that is configured to generate a first clock pulse to load the timer value to the timer module, a second clock pulse to compute when the timer module expires, and a third clock pulse when a pulse is generated at the timer expired output.
F11. The memory controller of F10, wherein the current snapshot counter value is provided to the timer module upon detection of the new command by the memory controller.
F12. The memory controller of F10 or F11, wherein the timer value corresponds to a number of clock cycles required to complete execution of the new command.
F13. The memory controller of any one of F10 to F12, wherein the current snapshot counter value corresponds to a number of clock cycles that remain for a current command being executed by a memory coupled to the memory controller will complete execution.
F14. The memory controller of any one of F10 to F13, wherein the at least one timer module generates a pulse at the timer expired output when a timer snapshot value maintained by the timer logic is equal to the sum of the current snapshot counter value and a timer value.
F15. The memory controller of any one of F10 to F14, wherein the clock gate logic is coupled to a clock enable output of the timer module.
F16. The memory controller of any one of F10 to F15, wherein the timer module includes two or more logic gates that function as a vector comparator to generate the pulse at the timer expired output.
F17. A method for controlling command-to-command timing in a memory controller, comprising:
detecting, by the memory controller, a new command request;
receiving, by a timer module of the memory controller, a current snapshot counter value from a free running counter, the current snapshot counter value indicating a first number of clock cycles for completing execution of a command being executed by a memory coupled to the memory controller;
receiving, by the timer module of the memory controller, a timer value for a second number of clock cycles to complete execution of the new command request;
summing, by the timer module of the memory controller, the first number of clock cycles and the second number of clock cycles as a timer snapshot value;
comparing a current timer snapshot value to the timer snapshot value;
generating a timer expired pulse when the current timer snapshot value is equal to the timer snapshot value.
F18. The method of F17, comprising using a first clock pulse to update a first register to store the timer value.
F19. The method of any one of F10 to F12 or F18, comprising using a second clock pulse to update a second register to store the timer snapshot value.
F20. The method of any one of F17 to F19, comprising using a third clock pulse to generate the timer expired pulse.

Although the technology herein has been described with reference to particular examples, it is to be understood that these examples are merely illustrative of the principles and applications of the disclosed technology. It is, therefore, to be understood that numerous modifications may be made to the illustrative examples and that other arrangements may be devised without departing from the spirit and scope of the present technology as defined by the appended claims.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description should be taken by way of illustration rather than by way of limitation of the subject matter defined by the claims. In addition, the provision of the examples described herein, as well as clauses phrased as “such as,” “including,” and the like, should not be interpreted as limiting the subject matter of the claims to the specific examples; rather, the examples are intended to illustrate only some but not all possible variations of the disclosed technology. Further, the same reference numbers in different drawings can identify the same or similar elements.

1. A memory controller, comprising:
a free running counter that maintains a count of a number of clock cycles remaining for a command to be executed; and
a timer logic coupled to the free running counter and including at least one timer module, the at least one timer module having a current snapshot input for receiving a current snapshot counter value from the free running counter, an input for receiving one or more timer values associated with a new command and an output, wherein the current snapshot input receives a snapshot counter value from the free running counter and a timer value associated with fully executing a current command, and
wherein the timer module generates a pulse at the output when a timer snapshot value maintained by the timer logic based on a sum of the current snapshot counter value and a first timer value.

2. The memory controller of claim 1, wherein the current snapshot counter value is provided to the timer module upon detection of the new command by the memory controller.

3. The memory controller of claim 2, wherein the first timer value corresponds to a number of clock cycles to complete execution of the new command.

4. The memory controller of claim 2, wherein the current snapshot counter value corresponds to a number of clock cycles that remain for a current command being executed by a memory coupled to the memory controller to complete execution.

5. The memory controller of claim 1, wherein the at least one timer module includes a gated clock input that is coupled to a clock gate logic.

6. The memory controller of claim 5, where the clock gate logic is configured to generate a first clock pulse to load the timer value to the timer module, a second clock pulse to compute when the timer module expires, and a third clock pulse when the pulse is generated at the output.

7. The memory controller of claim 6, wherein the clock gate logic is coupled to a clock enable output of the timer module.

8. The memory controller of claim 1, wherein the timer module includes a gated clock input that is coupled to a clock gate logic and is configured to operate using only three clock pulses.

9. The memory controller of claim 1, wherein the timer module includes two or more logic gates that function as a vector comparator to generate the pulse at the output.

10. A memory controller, comprising:
a free running counter that maintains a count of a number of clock cycles remaining for a command to complete execution; and
a timer logic coupled to the free running counter and including at least one timer module, the at least one timer module having a current snapshot input for receiving a current snapshot counter value from the free running counter, a timer value input for receiving a timer value associated with a new command and a timer expired output, wherein the current snapshot input receives a snapshot counter value from the free running counter and a timer value associated with fully executing a current command, and
wherein the timer module includes a gated clock input that is coupled to a clock gate logic and that is configured to generate a first clock pulse to load the timer value to the timer module, a second clock pulse to compute when the timer module expires, and a third clock pulse when a pulse is generated at the timer expired output.

11. The memory controller of claim 10, wherein the current snapshot counter value is provided to the timer module upon detection of the new command by the memory controller.

12. The memory controller of claim 11, wherein the timer value corresponds to a number of clock cycles to complete execution of the new command.

13. The memory controller of claim 11, wherein the current snapshot counter value corresponds to a number of clock cycles that remain for a current command being executed by a memory coupled to the memory controller will complete execution.

14. The memory controller of claim 10, wherein the at least one timer module generates the pulse at the timer expired output when a timer snapshot value maintained by the timer logic is equal to a sum of the current snapshot counter value and a timer value.

15. The memory controller of claim 10, wherein the clock gate logic is coupled to a clock enable output of the timer module.

16. The memory controller of claim 10, wherein the timer module includes two or more logic gates that function as a vector comparator to generate the pulse at the timer expired output.

17. A method for controlling command-to-command timing in a memory controller, comprising:
detecting, by the memory controller, a new command request;
receiving, by a timer module of the memory controller, a current snapshot counter value from a free running counter, the current snapshot counter value indicating a first number of clock cycles for completing execution of a command being executed by a memory coupled to the memory controller;
receiving, by the timer module of the memory controller, a timer value for a second number of clock cycles to complete execution of the new command request;
summing, by the timer module of the memory controller, the first number of clock cycles and the second number of clock cycles as a timer snapshot value;
comparing a current timer snapshot value to the timer snapshot value; and
generating a timer expired pulse when the current timer snapshot value is equal to the timer snapshot value.

18. The method of claim 17, comprising using a first clock pulse to update a first register to store the timer value.

19. The method of claim 17, comprising using a second clock pulse to update a second register to store the timer snapshot value.

20. The method of claim 17, comprising using a third clock pulse to generate the timer expired pulse.
